(19) United States
(12) Patent Application Publication
(10) Pub. No.: US 2022/0297369 A1
(43) Pub. Date: Sep. 22, 2022

(54) ADDITIVELY MANUFACTURED EXTRUDER COMPONENTS

(71) Applicant: ENTEK MANUFACTURING LLC, Lebanon, OR (US)

(72) Inventor: Craig Allen Benjamin, Lebanon, OR (US)

(21) Appl. No.: 17/635,336

(22) PCT Filed: Aug. 14, 2020
(86) PCT No.: PCT/US2020/046388

§ 371 Date: Feb. 14, 2022

Related U.S. Application Data
(60) Provisional application No. 62/886,825, filed on Aug. 14, 2019.

(51) Int. Cl. B29C 48/505; B29C 48/25; B29C 48/57; B29C 48/68; B29C 48/40

(52) U.S. Cl. CPC B29C 48/509; B29C 48/25684; B29C 48/57; B29C 48/6801; B29C 48/40; B29C 48/682; B33Y 80/00

(57) ABSTRACT

Disclosed are additively manufactured extruder components including a surface layer configured to contact extrudable material. The surface layer has a first additively manufactured metal composition. A base support for the surface layer has a second additively manufactured metal composition that is different from the first additively manufactured metal composition. A functionally graded material (FGM) is formed from the first and second additively manufactured metal compositions connecting the surface layer to the base support.

### RELATED APPLICATION

This application claims priority benefit of U.S. Provisional Patent Application No. 62/886,825, filed Aug. 14, 2019, which is hereby incorporated by reference in its entirety.

### TECHNICAL FIELD

This disclosure relates generally to additive manufacturing techniques for printing high-precision, high-wear, or highly corrosion-resistant parts, and, in particular, to printing screw and barrel components of an extruder machine.

### BACKGROUND INFORMATION

U.S. Pat. No. 8,595,910 of Benjamin et al. describes processes for restoration of worn metallic extrusion processing elements. Among other things, the processes entail use of a hot isostatic press (HIP), which is also employed in a similar manufacturing process for new extruder components. Creating a screw using a powdered metal HIP process consumes large amounts of energy to power a HIP furnace that produces a cylindrical blank from expensive powdered metal tool steel heated in a HIP canister. Additional time and energy are spent performing post-processing steps on the cylindrical blank. For instance, the blank is subjected to machining steps for creating different flight pitch configurations or kneading block lobe styles. The extensive machining also produces a relatively large waste stream of heavy metals because a large portion of the blank (e.g., greater than 10% by weight or volume) is cut away when creating flights and lobes. Furthermore, the blank is broached to create spline profiles. And once the part is machined, it also goes through another heat treat step to further harden the powdered metal material.

In a traditional barrel design, a cooling jacket is made via axial drilled holes (parallel to the bores), and cross drilled holes that connect them together. The holes then have CV plugs also referred to as expander plugs to cap off their ends. Cooling fluid is pumped from an inlet hole to an outlet hole. These CV-plug constructed cooling jackets are typically used as a flooded cooling passage. The cooling medium is free to flow through the cooling jacket until it reaches the outlet. There are also serial designs in which a specific path is defined in the barrel. In these designs, the cooling fluid is pumped from an inlet hole to an outlet hole, but there is typically only one path of flow from the inlet to the outlet. The serial design consists of cooling holes drilled axially about the barrel (parallel to the bores). Cross over channels are machined into both faces of the barrel, these channels connect the axial cooling holes and direct the fluid flow from hole to hole causing the flow path to be a serpentine pattern around the barrel. The connecting channels are capped off on both ends of the barrel. This cap consists of a ring inserted and welded into a channel just outside (towards the end faces of the barrel) of the cross over channels.

Additive manufacturing (AM, but also referred to as 3D printing) was initially developed for use as a prototyping tool. The technology was limited by slow fabrication speeds, limited selection of available materials, and relatively low accuracy, repeatability, and part durability. Over time, material availability has evolved from photopolymers to a wide variety of plastics, ceramics, metals and composites, thereby increasing the durability of printed parts.

More recently, AM technology has been adopted for use in medical and aerospace applications, in which materials like cobalt chrome, Inconel, aluminum, stainless steel, and titanium have been developed for printing. These materials have been deployed in applications in which softer, non-wear resistant materials are suitable. Maraging steel has been developed for applications requiring higher hardness but this material lacks wear resistance. Other attempts have tried M2 and M4 material.

There are several types of AM capable of producing metal parts. Four such categories of AM include material jetting, binder jetting, powder bed fusion, and direct energy deposition (DED).

Material jetting includes nanoparticle jetting in which metal particles are suspended in a liquid, which is essentially inkjet printed, and then the liquid is evaporated with heat. The resulting part is then sintered in a furnace.

Binder jetting is similar to material jetting, except instead of suspending particles, they are applied as a powder to which a binder is then applied. The part is then cured.

Powder bed fusion is a type of additive manufacturing that entails fusing powder using heat energy provided by an optical or electron beam. A 3D part is created one layer at a time using a fine powder as the print medium. Currently, there are two primary types of powder bed fusion that employ optical beams. A first type of powder bed fusion is called selective laser sintering (SLS). In SLS, a laser beam sinters powdered materials such as plastics, nylons, and ceramics. Direct metal laser sintering (DMLS) is a similar technology in which the powder is metal. A second type of powder bed fusion is called selective laser melting (SLM), also known as direct metal laser melting (DMLM) or laser powder bed fusion (LPBF). In SLM processes, a laser creates a melt pool in the powder bed. The melt pool quickly cools and solidifies to form parts.

DED includes laser engineering net shape (LENS) and electron beam additive manufacturing (EBAM). Instead of sintering or melting powder layers, feedstock is concurrently deposited and cured with heat energy.

### SUMMARY OF THE DISCLOSURE

ENTEK Manufacturing LLC of Lebanon, Oregon, the present applicant, has recognized that existing applications of AM techniques have not been optimized for extruder components. For instance, ENTEK recognized that AM technologies could be optimized to develop extruder components having one or more of the following advantages: they are near net parts entailing minimal post processing, contain multiple materials, and include voxels having voids or lattice structure to reduce raw material usage and weight and provide for optimized cooling (increased cooling jacket efficiency) and wear resistance.

Accordingly, disclosed are techniques for 3D printing methods, systems, and apparatuses, which allow for an extruder part to be printed as a near net shape, thereby greatly reduces the finish machining steps employed to obtain the tight tolerances specified for extrusion screw elements. In the context of extruder components, near net means no or a minimal (e.g., a small amount of less than 20%) portion of the printed component is machined away in post-processing steps. Near net, therefore, encompasses no or minimal post-processing.

Some other advantages of 3D printed parts over conventionally made parts include the following: reduced material usage; less finish machine work; reduced lead times; all processing is performed in house; additional part customizations are possible; there are new design possibilities that are not possible due to conventional machining restrictions; reduction of fixturing and tooling; elimination of raw material prep, i.e., no hot isostatic press (HIP) cans; fewer manufacturing steps involved; less labor involved; and parts printable unattended.

AM screws and, more generally, any multi-material AM-produced extruder component (including barrel segments or replaceable sleeves), may be produced with lighter internal materials or voids that reduce weight and material usage. Thus, the AM-production techniques reduce both (1) material consumption in production, which provides an initial economic advantage, and (2) the end weight of the goods, which provides subsequent economic advantages in terms of reducing shipping and operating costs. Moreover, these advantages are more pronounced for larger parts, such as barrels.

It is estimated that conventional manufacturing consumes at least four to six times more energy than metal AM. Furthermore, by using multi-material printing, the HIP consolidation/cladding step can be skipped in some embodiments, saving even more energy by printing parts at near net shape and including internal lattices (i.e., saving material) or multiple materials (optionally at full density) and combining ductile and wear resistant materials.

In terms of reduced operating costs, the reduction in weight is beneficial for ease of installation (e.g., saving on labor costs) and improved centering of screws in barrel bores. Compared to situations/applications in which the centering is poor or compromised, improved centering extends the useful life of the part by reducing wear as a result of decreased normal forces due to gravity. For instance, because an AM interior may be made less dense and weighs less than a conventional solid core, it is more readily centered in the extruder bores. Extrudate flowing through the extruder presents hydrodynamic forces on the screws. These forces tend to center the screws in the extruder bores. The reduction in screw weight results in a reduction in the normal force (F=μ·N) thereby reducing the frictional forces in the system. Accordingly, the contact motion friction wear acting upon the screws and the barrels is reduced. Less wear prolongs the useful life of screws and barrels, which, as explained next, may also be printed and therefore benefit from the aforementioned advantages of reduced material consumption and weight.

Additional aspects and advantages will be apparent from the following detailed description of preferred embodiments, which proceeds with reference to the accompanying drawings.

### BRIEF DESCRIPTION OF THE DRAWINGS

FIGS. 1 and 2 are sectional and cross-sectional views of a conventional bi-metallic screw produced using a prior art HIP process, with the cross-sectional view of FIG. 2 taken along lines 2-2 of FIG. 1.

FIGS. 3 and 4 are sectional and cross-sectional views of a bi-metallic screw having a 3D printed base with a harder tip of flights, in which the cross-sectional view of FIG. 4 is taken along lines 4-4 of FIG. 3.

FIG. 4A is a detail view taken from an area shown in FIG. 4, showing an enlarged view of a functionally graded material (FGM) forming an interface of the 3D printed base with a harder tip of flights.

FIG. 4B is a detail view taken from a similar area as that shown in FIGS. 4 and 4A but showing an enlarged view of LENS cladding applied during a separate manufacturing step the 3D printed base, according to the prior art.

FIGS. 5 and 6 are sectional and cross-sectional views of an additively manufactured bi-metallic printed screw having a printed exterior surface, according to one embodiment of this disclosure, in which the cross-sectional view of FIG. 6 is taken along lines 6-6 of FIG. 5.

FIG. 7 is an end view of an additively manufactured printed barrel having an axial bore lining of a first additively manufactured metal composition and a base support for the axial bore lining, the base support having a second additively manufactured metal composition that is different from the first additively manufactured metal composition.

FIGS. 8A, 8B, and 8C are isometric views showing, respectively, a voxel populated by beams connecting nodes, shells (or meshes) extending between the nodes and beams of FIG. 8A, and a lattice comprising multiple populated voxels of FIG. 8A and showing options for a lattice skin and a solid skin.

FIGS. 9A and 9B are isometric views of printed screw segments including, respectively, conveying and kneading block screw segments.

FIG. 10 is a sectional view taken along lines 10-10 of FIG. 9A.

FIG. 11A is a detail view taken from an area shown in FIG. 10, showing an enlarged view of a beam-shaped lattice.

FIG. 11B is a detail view taken from a similar area as that shown in FIGS. 10 and 11A but showing a triply periodic minimal surfaces (TPMS) based lattice of the gyroid type.

FIG. 12 is an isometric view of a barrel segment showing optional heating or cooling devices.

FIGS. 13 and 14 sectional views taken along, respectively, lines 13-13 and 14-14 of FIG. 12 and showing an internal beam-shaped lattice.

FIG. 15A is a detail view taken from an area shown in FIG. 13, showing an enlarged view of the beam-shaped lattice.

FIGS. 15B and 15C are detail views taken from a similar area as that shown in FIGS. 13 and 15A but showing a gyroid-shaped lattice having, respectively, uniform and variable volume fractions.

FIG. 15D is another detail view taken from a similar area as that shown in FIGS. 13 and 15A but showing a combined gyroid- and primitive-shaped lattice with a hybrid region therebetween.

FIGS. 15E, 15F, 15G, 15H, 15I, and 15J are isometric views showing different lattice shapes including, respectively, octet truss, gyroid skeletal, gyroid sheet, diamond skeletal, diamond sheet, and vintiles shaped variants.

FIG. 15K is an isometric view of a dual gyroid lattice configured as a heat exchanger.

FIGS. 16 and 17 are an isometric and a sectional view, taken along line 17-17 of FIG. 17, showing an additively manufactured extruder vent having an integral porous region for venting gasses from an extruder barrel.

### DETAILED DESCRIPTION OF EMBODIMENTS

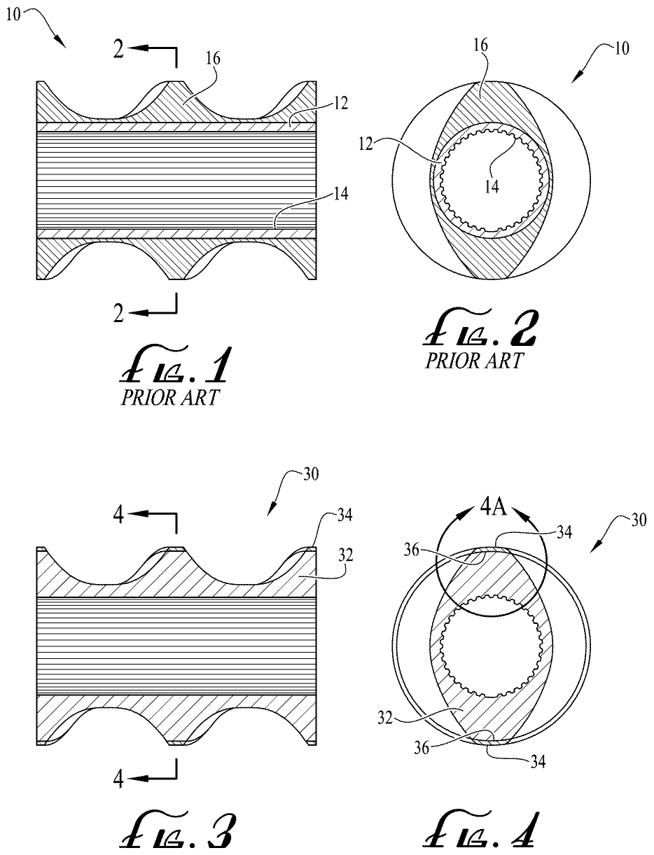

Some screw products include a so-called bi-metallic material makeup, as shown in a screw 10 of FIGS. 1 and 2. An inner core 12 defining a drive spline 14 (FIG. 2) is a cylindrically shaped 1018 mild steel that is soft and ductile. An outer shell 16 forming an area encompassing inner core 12 is made from wear resistant powdered metal tool steel. This bi-metallic material is made via a HIP process that densifies the powdered metal and bonds outer shell 16 component to inner core 12.

Multiple AM Materials and Functionally Graded Material for Extruder Components

ENTEK has employed AM in developing a process for 3D printing solid, single-material extruder screw and barrel elements. AM also provides an ability to define gradients, i.e., a functionally graded material (FGM), between different metals such as a ductile support material and a wear surface material.

An FGM is characterized by a variation in composition and structure throughout a given volume. This graded variation in chemistry and microstructure enables many different combinations of materials to be co-processed. These combinations include metal-metal, metal-ceramic, ceramic-ceramic, and ceramic-to-polymer.

FGMs allow stresses resulting when combining materials with mismatched thermal expansion properties to be distributed across a transitional region. FGM technology spreads these stresses out over a larger area in a gradient. It has been shown in research that thermal stresses can be reduced as much as 30% by the use of FGM. (Yoshikazu Shinohara, in Handbook of Advanced Ceramics, Second Edition, 2013).

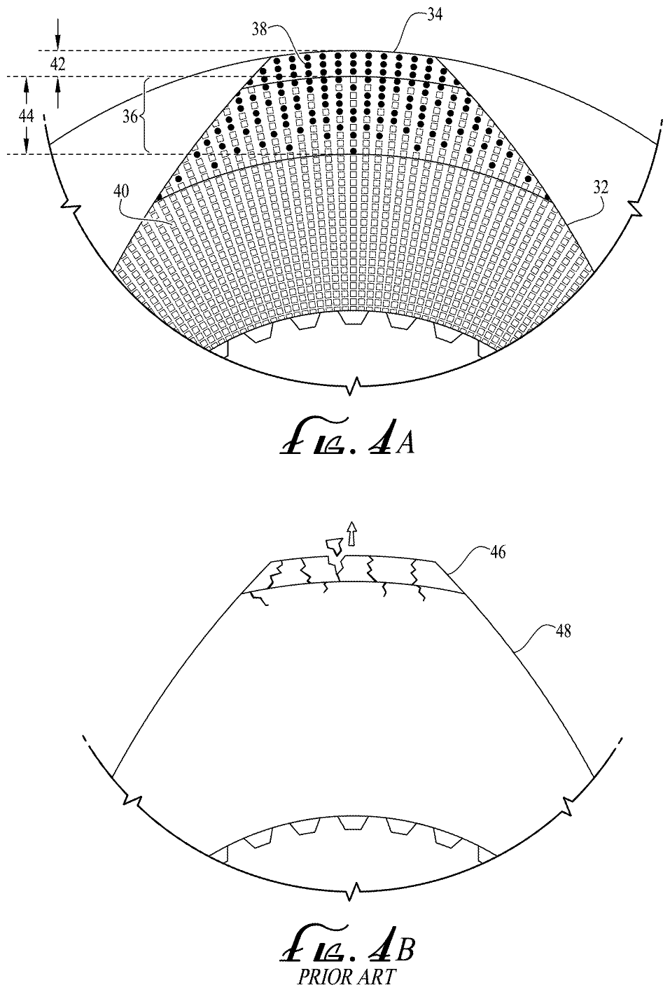

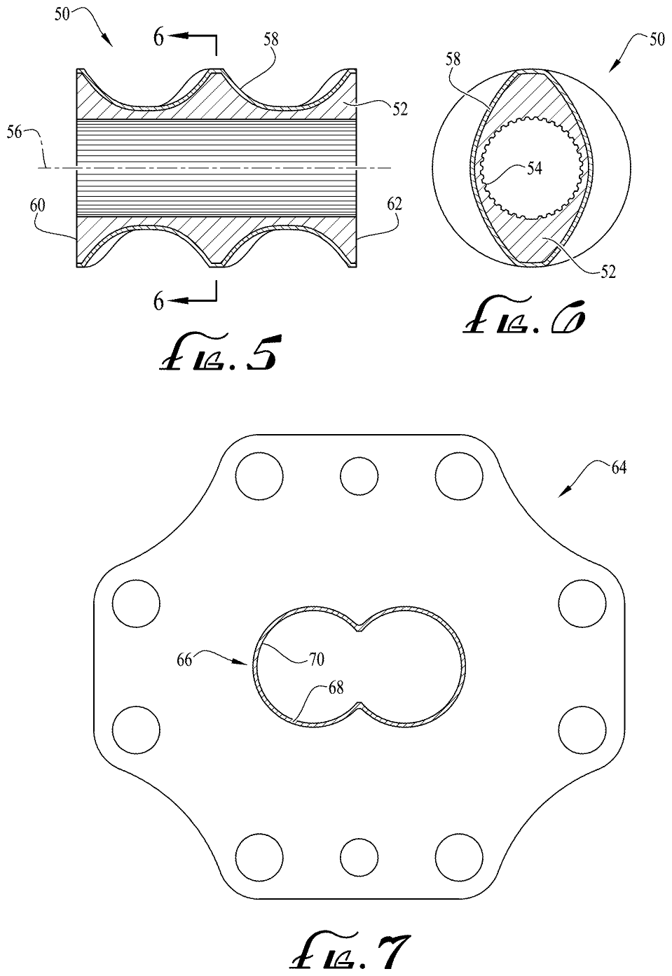

A benefit to FGM technology is the ability to employ selective powder distribution within a 3D printing build cycle. Particle sizes can be controlled and varied as a way to control sintering properties. This enables materials with completely different compositions to be processed with the same laser parameters and scan strategies. For example, FIGS. 3, 4, and 4A show a 3D printed screw 30 having an Inconel 718 base support 32 and Colmonoy 4 surface layer 34 defining tips configured to contact extrudable material. Colmonoy 4 material is a nickel-based material, but it has elements in it providing increased wear resistance superior to that of base support 32. Other wear- or corrosion-resistant additively manufactured metal compositions can be applied this same way. An additively manufactured metal composition includes a metal material, metalloids and metalloid-containing materials (e.g., silicon carbide), composites having metal materials (ceramics metal matrix composites), and other materials capable of being used in fabrication of extruder components.

Printing a tough, ductile base support 32 using Inconel feedstock while also printing a brittle, hard surface layer 34 at tips of flights during a common AM process provides for a reduced stress, tightly coupled FGM transitional region 36 formed from the first and second additively manufactured metal compositions connecting surface layer 34 to base support 32. Specifically, FIG. 4A shows that FGM transitional region 36 defines a gradual transition from a first additively manufactured metal composition 38 (e.g., Colmonoy 4 represented as black circles forming surface layer 34) to a second additively manufactured metal composition 40 (e.g., Inconel represented as squares forming base support 32). In some embodiments, the gradual blending from composition 40 to composition 38 in FGM transitional region 36 is achieved using LPBF or binder jetting printing techniques combined with selective powder deposition.

Thicknesses of the materials may vary depending on the extruder application. In one embodiment, surface layer 34 has a thickness 42 equal to about 2.5 percent of an extruder bore diameter. FGM transitional region 36 has a thickness 44 equal to about 7.5 percent of the extruder bore diameter. The distribution of black circles and squares at various points along thickness 44 represents the gradient of FGM transitional region 36. In some embodiments, the distribution defining an FGM transitional region may be realized through a linear, stepwise, sigmoid, or other metal-to-metal transitions are also possible.

The conventional methods of using HIP consolidation/cladding or LENS to produce bi-metallic extruder components creates a distinct interface between the two materials. This distinct interface limits the material combinations. Materials with similar thermal expansion coefficients must be used, as thermal stresses are concentrated at this abrupt interface, and cracking is an issue. FIG. 4B, for example, shows a prior art example in which LENS-cladded tips 46 of flights are applied to a DMLS 3D printed base 48 during a separate manufacturing process. This process uses a laser to create a melt pool, powder or wire is fed into the melt pool and deposited onto a substrate. For some screw parts, the thickness of the cladding is around 0.030″ thick (and will vary depending on screw size being made), and the feedstock is a powder. In other words, the cladding is applied atop the base support such that the transition between metals appears as a discrete step transition. Often there is a thermal expansion mismatch between the base support material and the surface cladding material. The cladding process results in captivated thermal stresses within the surface clad layer and the base support. These stresses are relieved when the part is subject to heat, and result in cracking of the surface layer and occasionally the base support material. The stress fractures in the surface layer material contribute to the material breaking free from the base support and potentially fouling the extruder barrel and screw components or extrudable material.

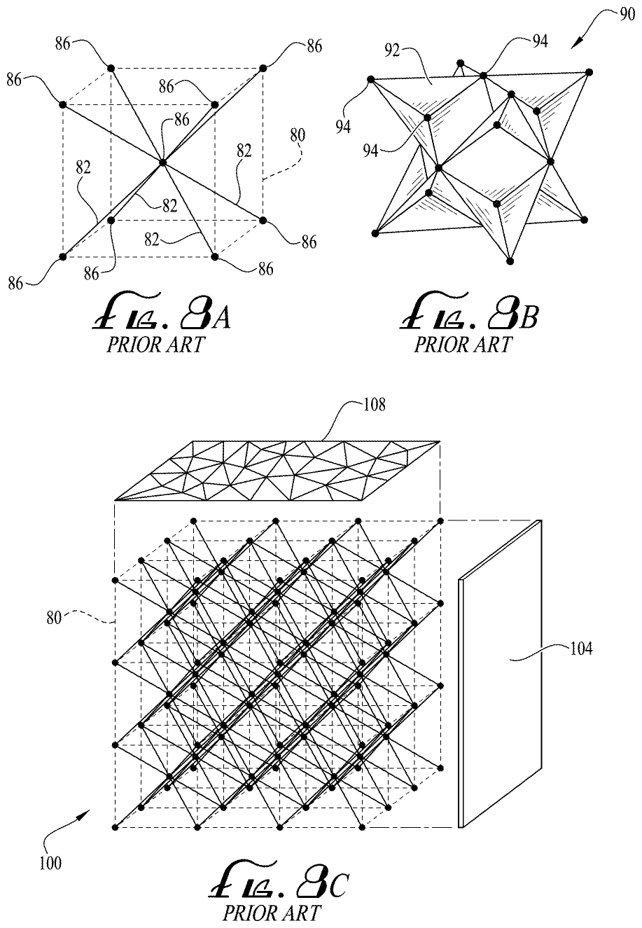

FIGS. 5 and 6 show an example of multi-material screw segment (or simply, screw) 50 constructed using a multi-material additive manufacturing process. A 3D-printed inner core 52 defines drive splines 54 and includes a cross-sectional geometry that changes along a longitudinal axis 56 of screw 50 so as to define lobes or flights. In this specific example, the geometry changes to generally define the shape of the flights and channels therebetween for a conveying extruder screw segment, but other shapes are possible (e.g., kneading block extruder screw segment). Furthermore, other internal drive geometries possible, such as, for example hexes, pins, and other shapes.

A 3D-printed outer shell 58 encompasses inner core 52. To encapsulate the entire surface of screw 50 as shown, two AM embodiments are summarized as follows.

A first embodiment entails printing inner core 52 using DMLS or other type of AM and then cladding it using a LENS (or other) process. To clad entire outer surface of inner core 52, however, multiple passes with a LENS process head are made. The LENS process head is movable in three dimensions to accommodate multiple outside diameters of inner core 52. For example, a face 60 of inner core 52 is placed atop a table jig that rotates inner core 52 as a LENS process head moves along and clads the outside diameter, working upward from face 60 to an opposite face 62. In this embodiment, as the process head moves upward, it also moves inward and outward as inner core 52 turns. Additional tilt angles of the process head are also useful to maintain a fixed angle between the melt pool and the sloping exterior surface angles of inner core 52.

Skilled persons will appreciate that, in the aforementioned embodiment, an FGM may be optionally included using the techniques described previously. For instance, the gradient could be formed by employing DED AM techniques (e.g., LENS), starting with the same material as that of inner core 52 and transitioning to a wear- or corrosion-resistant material to clad to the outside of screw 50 to form outer shell 58. This approach would reduce stresses, as previously described. Furthermore, other AM process are also possible. For example, Joule printing used wire feedstock in which wire is melted by passing a current though it and into the part in contact with the electrified wire.

A second embodiment entails printing using multi-material powder bed fusion, multi-material binder jet, or other multi-material AM process. Accordingly, each printed layer of the part includes multiple metal types and multi-metal interfaces for compatible metal materials.

A laser provides an accurate spot size (weld) pool that enables for thin layers of material to be deposited on to the substrate. This added control avoids waste and additional post processing when overlaying directly onto a screw flight. Depending on the tolerance of the process, chasing internal drive spline 54 is optional. Chasing is re-cutting the spline area in order to hold to a dimension that is not able to be held by the printer.

Also optional are grinding the outside diameter of screw 50 to about ±0.001″ tolerance and finish grinding parts to overall length specification of about ±0.001″. The latter grinding process also times (clocks) the screw flights to the spline profile. Timing of the screw flights to the internal spline profile is desire so as to maintain screw-to-screw intermesh gap in the extruder.

CAD model geometry may be modified from the nominal geometry so as to accommodate optional post-printing processing. For instance, additional material is added to the part features that are subjected to post-print finishing. In tests, ENTEK added about 0.010″ to both ends of the part for a total of about 0.020″ overall length. It also added about 0.010″ to the outside diameter of the part. The amount of extra material was determined empirically and may vary for some other applications. The amount may also vary due to the AM technology that is being used. For example, BJ printing may employ more machine stock than DMLS.

Compared to the conventional bi-metallic embodiment of FIGS. 1 and 2, the geometry of inner core 52 changes along longitudinal axis 56, and outer shell 58 maintains a consistent width. The volume of outer shell 58 is greatly reduced in that it becomes a relatively thin layer (e.g., about 1-3 mm thick). As a result, the geometry of the inner core 52 need not be cylindrical. Inner core 52 geometry is simply smaller version of the screw geometry.

Compared to the cladded version of FIGS. 3, 4 and 4A, outer shell 58 encompasses the entire flights—not just hardfacing the tips. Hardfacing the entire flights provides for additional resistance to abrasion that often results from an added filler material like fiberglass in the polymer being processed. Hardfacing or encapsulation could also be used to prevent corrosion. For example, iron-based screw (base material) can be encapsulated with a nickel or cobalt based overlay material, which could reduce expense compared to fabricating an entire screw element from nickel-based material like Inconel 625 or 718.

Multi-material screw 50 also provides a reduction in the amount of wear resistant powdered metal material that is needed. The bulk of screw 50 is made up of inner core 52, which can be made from a less expensive material. For instance, inner core 52 can be made from a ductile material that will handle the torque load that is applied to screws as they run in the extruder. Thinner, outer shell 58 allows for a harder (more brittle) material to be used so that the cracking potential is reduced.

In terms of materials that may be used, metal powder specifications for the conventional HIP process are not as tight as the requirements for the DMLS 3D printing process. For the conventional HIP process, a −32 mesh powder is suitable. A −32 mesh is equal to 792 micron. Thus, every particle is smaller than 794 micron, in some embodiments. For the DMLS printing process, however, a typical powder specification is 45/15 micron. Accordingly, the particle size is smaller than 45 micron and larger than 15 micron, in some embodiments.

Examples of the types of materials that may be used for an extrudate contacting surface include: tool steels such as A2, D2, M2, M4, H-13, H-11, 4140, Nitride 135, and 4340; powdered metal tool steels such as 9V, 10V, S90V, 15V, MPL-1, CPM 110V, and CPM 125V; stainless steels such as 17-4, 304, 316, and 440C; nickel-based materials such as Inconel 625, Inconel 718, Hastelloy C276, Colmonoy 4, Colmonoy 56, and Haynes 242; cobalt-based materials such as Stellite 6, Stellite 12, and Stellite 21; carbide metal matrix composites such as 70% WC-MMC (nickel-based, 70% by weight WC), 60% WC-MMC (nickel-based, 60% by weight WC), and other percentages by weight are possible; and ceramics metal matrix composites.

Examples of the types of materials that may be used for a base support surface include: iron-based materials such as 1018, H-13, H-11, 4140, Nitride 135, and 4340; stainless steels such as 17-4, 304, 316, and 440C; and nickel-based materials such as Inconel 625 and Inconel 718.

Examples of printable powdered metals that are currently available include the following: Alsi10Mg, 316 L stainless steel, Maraging Steel (C300), 17-4PH Stainless Steel, Titanium-6Al-4V, Inconel 625, Inconel 718, H-13, M2 tool steel, and Cobalt Chrome. These materials may also be tailored for use in manufacturing FGM multi-material parts.

Inconel 718 and Inconel 625 are corrosion resistant materials that perform well in extrusion applications producing fluoropolymers. Melt processing of fluoropolymers may give off hydrofluoric acid, which is extremely corrosive. The temperatures required for processing accelerate the corrosion. Inconel happens to be one of the materials that is used for processing fluoropolymers. The fact that Inconel is a nickel-based material allows it to resist hydrofluoric acid corrosion. Other materials, including those optimized for AM and applications benefiting from increased wear and corrosion resistance, are also possible.

ENTEK has tested Inconel 718 printed screws in its 27 mm and 43 mm extruders rated for, respectively, 130 and 565 Nm/shaft. No failures have been detected. The toughness of Inconel 718 material was superior to that of 10V material (i.e., a high wear material used in twin screw extruders). In terms of density, 3D printed Inconel 718 material as measured by ENTEK has a density of 8.15 g/cc; which is comparable to that of traditionally made Inconel material having a density of 8.19 g/cc. 3D printed MS1 (maraging steel) has a density of 7.98 g/cc, which is also comparable to that of traditionally made maraging steel having a density of 8.1 g/cc.

In addition to the aforementioned wear- and corrosion-resistant AM materials, optional processing techniques also provide increases in the wear resistance of AM-formed Inconel (or more generally, nickel-based) materials employed in the fluoropolymer industry. For example, Boriding (also known as Boronizing) is an example of one such process that may be used in addition to or as a substitute for laser cladding of Inconel 718 screws or other parts. This process entails diffusion of Boron atoms from powder media surrounding parts into a steel surface such that the atoms react with iron (Fe) to form Fe₂B compounds having high hardness. The process works well for steels, and in nickel-based materials it creates a particularly harder wear surface. Nickel alloys like Inconel 625 and Inconel 718 have a significant amount of Iron in them that is leveraged for the Boriding process.

FIG. 7 shows an additively manufactured printed barrel segment 64. A base support 66 defines an axial bore lining 68, and in which a surface layer 70 of a first additively manufactured metal composition forms an inner shell hardfacing axial bore lining 68. A second additively manufactured metal composition forms axial bore lining 68. As described previously, the first and second additively manufactured metal compositions are different from each other such that an FGM transitional region (not shown) is formed between surface layer 70 and base support 66. In another embodiment (not shown), an axial bore lining is a replaceable barrel sleeve.

In some embodiments, an additional heat treatment helps to refine an AM produced material. In other cases, an additional heat treatment is not performed. For example, Inconel 718 parts need not undergo a heat treat step, although other materials, such as a more wear resistant material, might benefit from a heat-treating step. Relatedly, sometimes a stress relief is done to relieve stresses induced in the part during printing.

In another embodiment, for parts preferably processed using HIP, a mild tool steel and a powdered metal specific alloy could be co-deposited using a selective powder deposition system, and only the mild steel exterior would need to be sintered to act as a HIP casing. Thus, the powdered metal alloy would be densified during the HIP process. For instance, this technique could be employed for producing a prefilled casing with piping that would enable weld sealing this casing under vacuum after printing, just as in HIP-produced parts produced from welded sheet metal. The remainder of the HIP processing can then follow established steps. Furthermore, an optional FGM transitional region could be established between the mild tool steel and a powdered metal specific alloy but depositing a gradient mixture of materials beginning at the inside surface of the mild steel and extending inward toward the powdered metal specific alloy.

In another embodiment, a core is formed using conventional HIP processes or billet material. A DED material is then applied to the core to establish the base support on which the FGM transitional region and surface layers are simultaneously formed during the DED process.

### Interior Lattice Structures

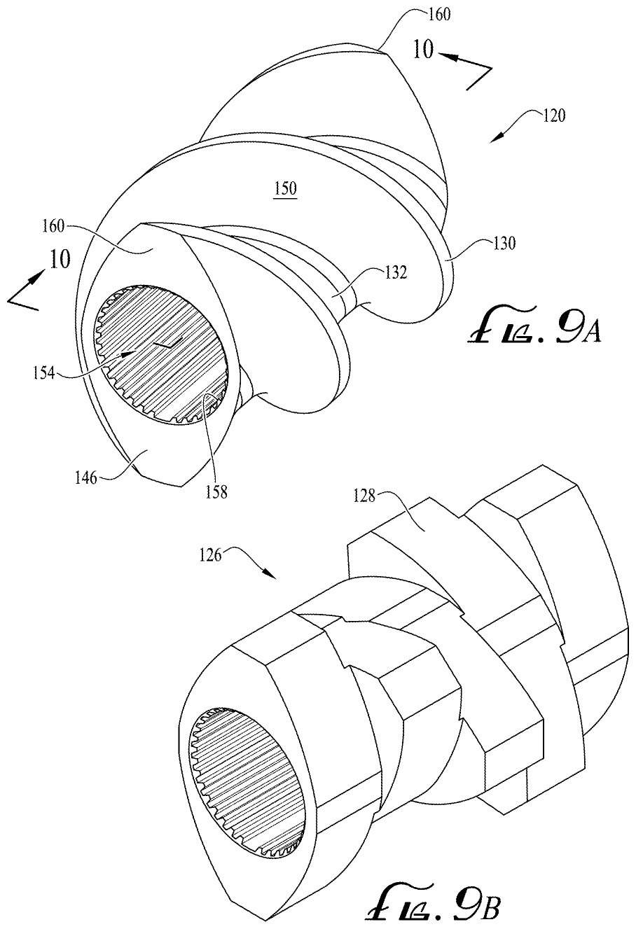

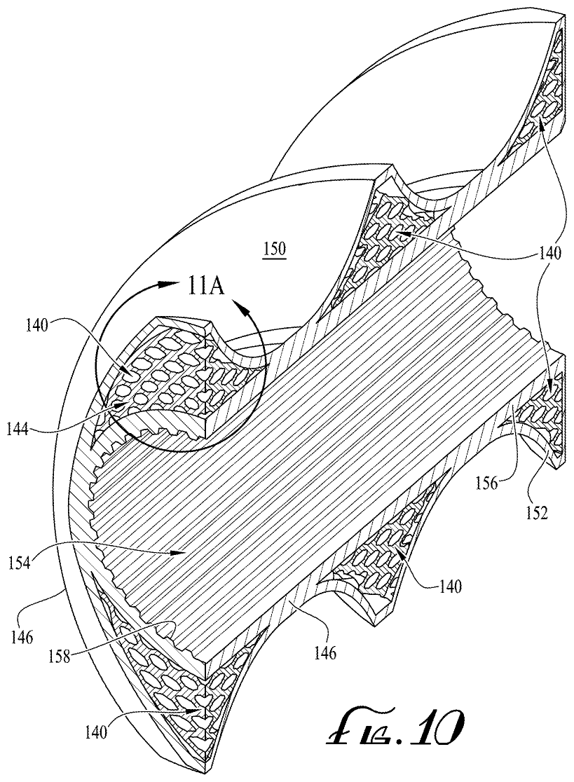

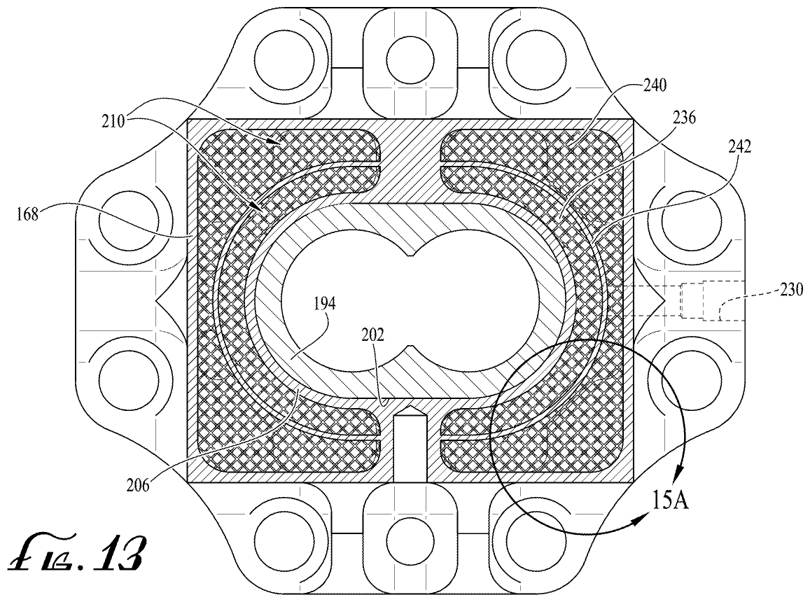

FIGS. 9A-15D show extruder components having printed internal lattice structures, which are initially introduced by way of simplified beam-shaped lattice examples of FIGS. 8A-8C. Specifically, FIG. 8A shows a voxel 80 populated by beams 82 connecting nodes 86 at the center and corners of voxel 80. FIG. 8B shows that, in some embodiments, shells (or meshes) 90 are formed between nodes 86. For instance, a face 92 extends between three vertices 94, and some or all of vertices 94 may be one of nodes 86. Finally, FIG. 8C shows how a lattice structure 100 (or simply, lattice 100) is formed from multiple voxels 80. Lattice 100 may be enclosed with an impervious flat-sided skin 104 or an impervious lattice skin 108.

More generally, AM lattices are two or three-dimensional micro-architectures comprised of a network of beams, or struts, intersecting at nodes, and thereby defining planar (i.e., 2D) or volumetric (i.e., 3D) voxels having voids (or gaps) encapsulated by associated beams and nodes, which are usually also part of an adjacent voxel. Lattices dramatically reduce weight compared to a solid part while retaining structural integrity. There are many different lattice structures that can be employed. When choosing the lattice structure that is appropriate for a specific application, some or all of the following lattice characteristics may be varied: voxel structure, voxel size, density of selected material, and voxel orientation. Thus, the shape of cells in lattice structure 100 can be configured in many ways, as shown and described later in this disclosure.

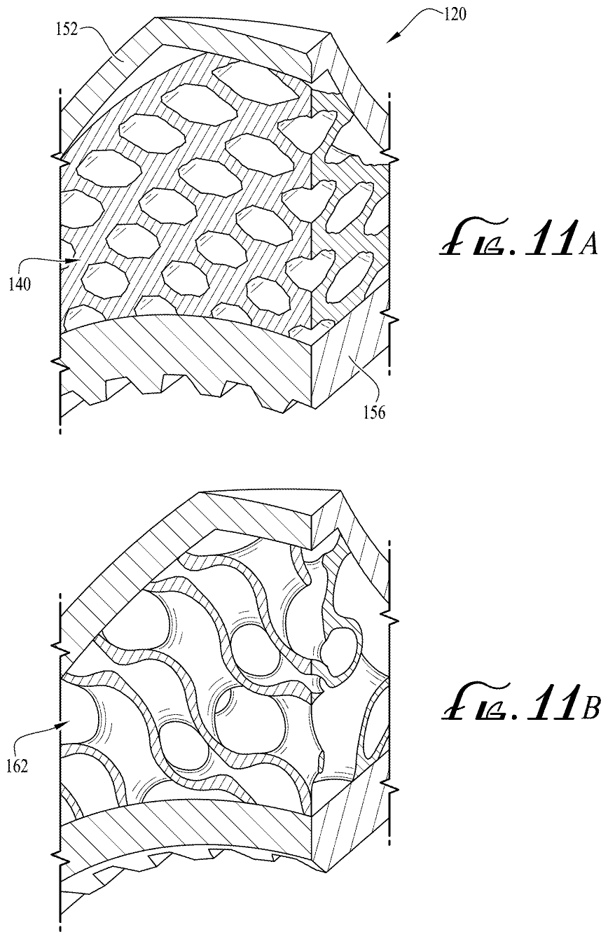

FIGS. 9A-11B show a printed conveying screw segment 120. FIG. 9B is a printed kneading block screw segment 126, which includes lobes 128 instead of flights 130 and channels 132 (FIG. 9A). Both types of screw segments, however, include a printed internal beam-shaped lattice structure 140 in an interior 144, examples of which are shown in FIGS. 10 and 11A.

Lattice structure 140 is formed within a structural support frame 146 that defines an impervious screw surface 150 acting as an outer support frame 152 (FIG. 10) and an axial aperture 154 acting as an inner support frame 156 (FIG. 10). Accordingly, lattice structure 140 is formed in interior 144 between outer and inner structural support frames additively manufactured as a unitary tubular screw component. In screw segment 120, portions of support frames 152 and 156 merge at locations of channels 132, establishing a spiral cut lattice in interior 144.

Impervious screw surface 150 is configured to contact extrudable material, so it is impervious to gas and fluid intrusion. For instance, it may be printed as a wear- or corrosion-resistant surface layer, either on tips of flights 130 or lobes 128 or fully encompassing surface 150, as described previously.

Axial aperture 154 is configured to couple to a drive shaft (not shown). For instance, axial aperture 154 includes printed splines 158 (or other shapes).

In some embodiments, solid end faces 160 and other exterior portions of screw segment 120 fully encapsulate interior 144. In other words, screw 120 has the external appearance of a traditional element. Furthermore, in some embodiments, one or more orifices (not shown) are included in end faces 160 or other exterior surfaces. Such orifices are used to evacuate unsintered powder and can be welded closed after the powder is removed.

FIG. 11B shows another embodiment for a lattice structure in the form of a gyroid-shaped lattice structure 162. Additional types of lattice embodiments are discussed later in this disclosure.

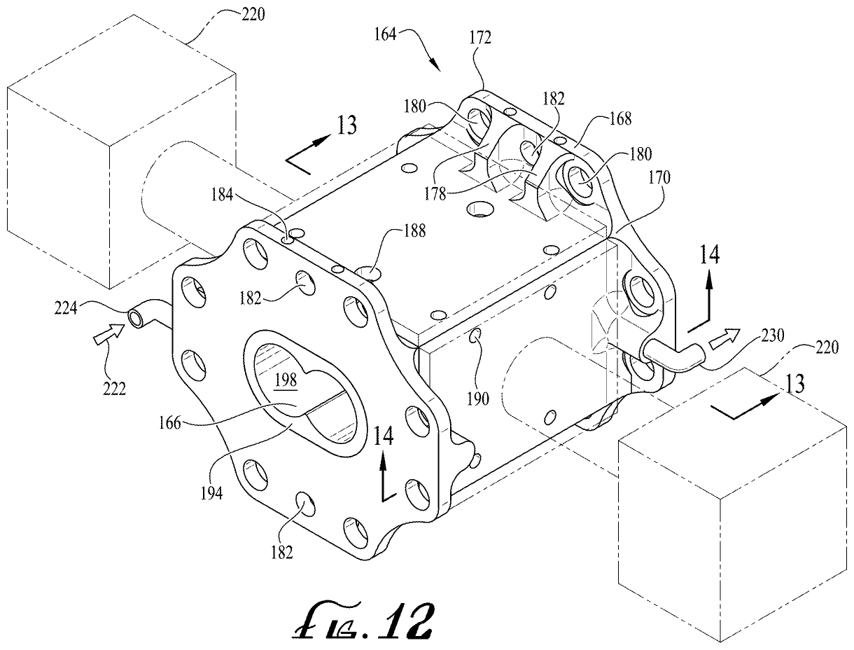

FIGS. 12-15A show a printed barrel segment (or simply, barrel) 164 including twin-barrel axial apertures 166 configured to house an extruder screw component. A structural support frame 168 defines axial apertures 166 and an impervious exterior surface 170. Exterior surface 170 includes printed flanges 172 supported by printed gussets 178. Adjacent gussets 178 are flange bolt holes 180 for bolting segment 164 to an abutting segment. Alignment dowel holes 182 and mounting holes 184 are also formed in surfaces of flanges 172. Replaceable barrel sleeve mount bolt holes 188 and additional heater mount bolt holes 190 and are also included.

Replaceable sleeve 194 has an inner surface 198 defining axial apertures 166. FIG. 13 shows that sleeve 194 has an outer surface 202 confronting an inner axial wall 206 of structural support frame 168, adjacent a beam-shaped lattice structure 210. In other embodiments (not shown), a replaceable barrel sleeve has an outer surface confronting an outer portion of a lattice structure (i.e., directly contacting the lattice without inner axial wall therebetween). Some other embodiments include an integral (non-replaceable) barrel in which an axial lining is formed atop a lattice (e.g., a lattice skin) or a hardfacing on an inner impervious axial wall adjacent the lattice structure.

FIG. 12 shows two optional L-shaped electric plate heaters 220 mounted to exterior surface 170 of barrel segment 164. It is estimate that a heater temperature of 400 F maybe used to heat up a cooling jacket (i.e., exterior surface 170) temperature of 70 F and a barrel temperature of 70 F.

AM technologies provides the capability to build in new geometries (triangular, square, elliptical, and other geometries) for passages that have been impossible to produce using conventional machining. These specialized passages can be placed closer to barrel bores and constructed in paths crossing back and forth throughout the barrel. These passages increase the effectiveness of the cooling jacket.

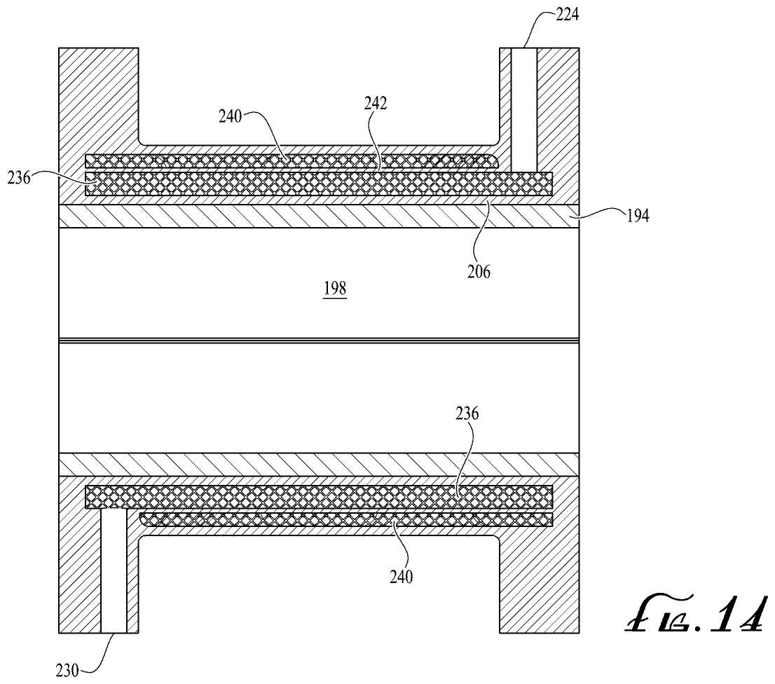

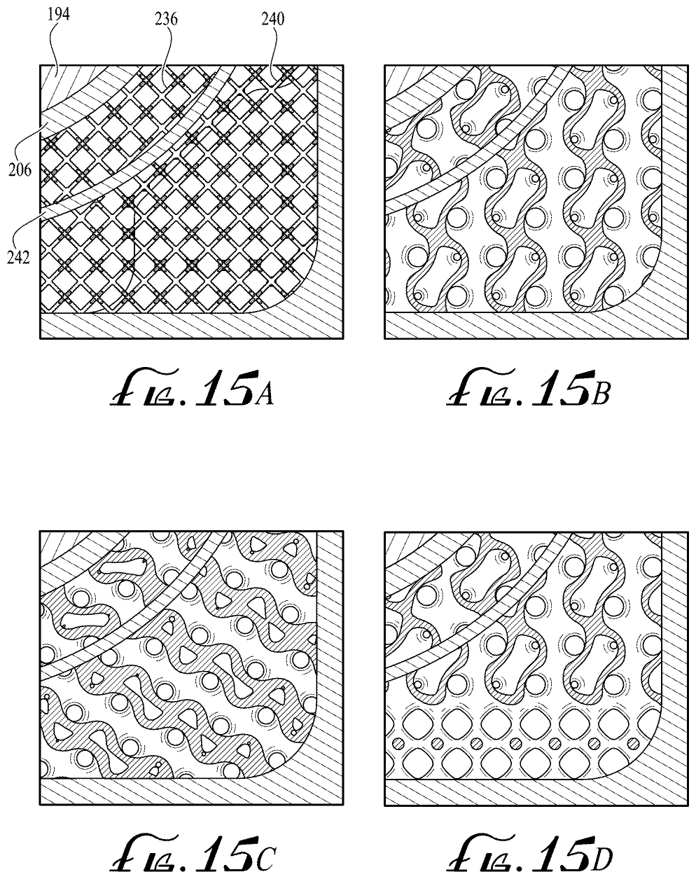

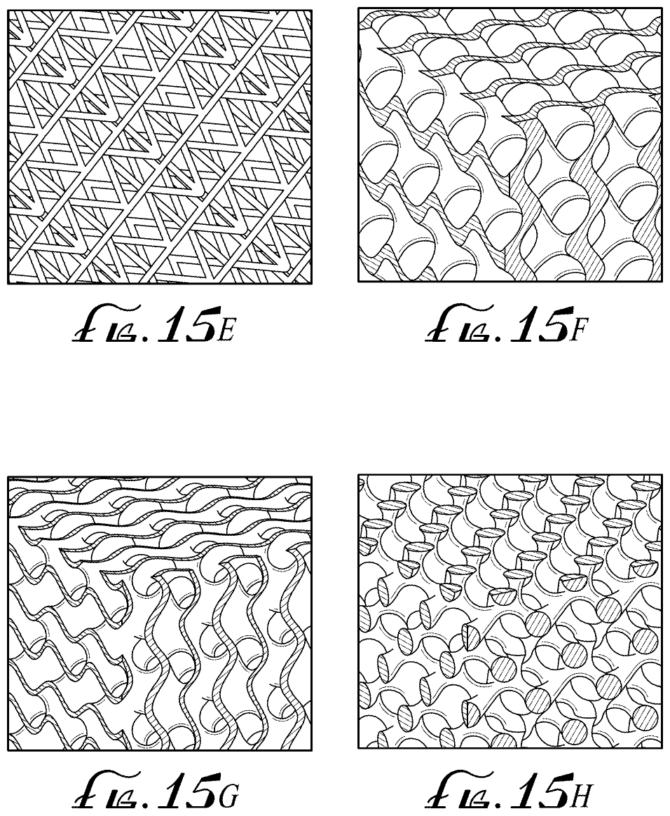

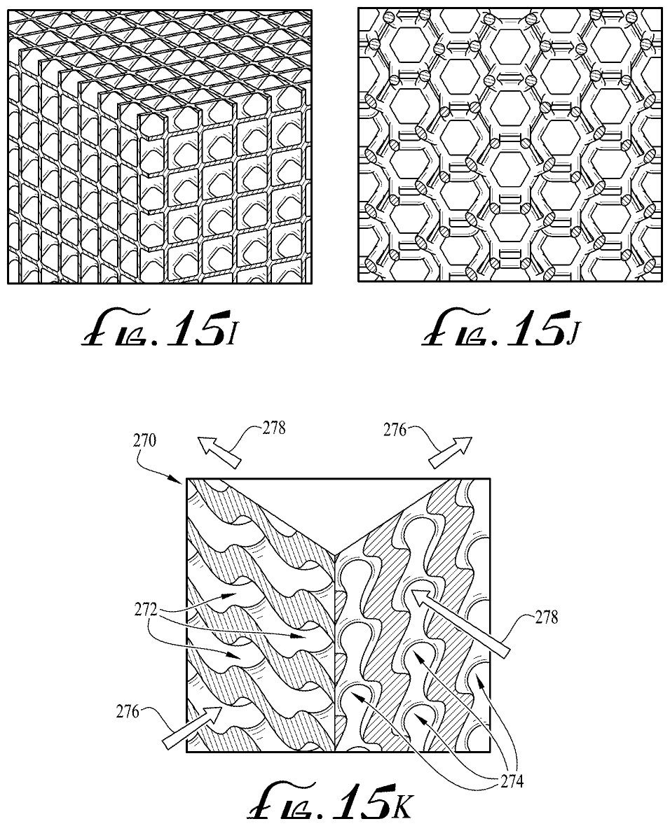

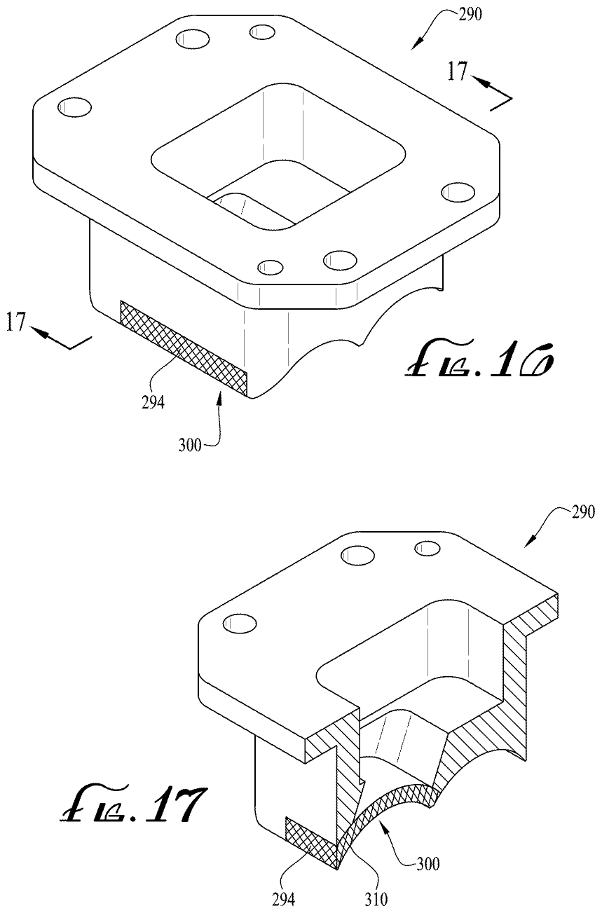

Relatedly, lattice structure 210 can also be employed as coolant passages. Thus, lattice structure 210 is used to act as a conductive path to transfer the heat to the convective cooling of the fluid/gas throughout lattice 210. With forced flow through such arduous paths, turbulence is introduced increasing the convection coefficients, so heat transfer effectiveness is increased and otherwise tunable. By combining specialized geometric passages and lattice structures, cooling and heating capacity may be further optimized. Additional aspects of heating or cooling are described later with reference to FIG. 15J.

For example, FIG. 12 shows a heat-transfer fluid 222 is pumped through an inlet port 224 and exits an outlet port 230. As shown in FIGS. 13-15A, in some embodiments, heat-transfer fluid 222 flows through lattice structure 210. In some embodiments, lattice structure 210 includes a first region 236 and a second region 240, which are separated by a barrier 242 preventing fluid permeability between first region 236 and second region 240. Ports 224 and 230 are in fluid communication with first region 236 such that heat-transfer fluid 222 flows through it and need not flow through second region 240. In other embodiments, heat-transfer fluid flows through both regions, or there is a single region. It is estimated that an inlet pressure 90 psi and cooling water temperature of 90 F may be used for cooling a barrel temperature of 400 F.

FIGS. 15B-15J show various other types of lattice structures suitable for use in barrel 164 or a screw segment. For instance, FIG. 15B shows a gyroid lattice having a uniform volume fraction in region 236 and 240. In contrast, FIG. 15C shows a gyroid lattice having different volume fractions in regions 236 and 240. A variable volume fraction may also be established in a single region, in some embodiments, to optimize the lattice wall thickness for thermal transfer and rigidity properties. In another embodiment, FIG. 15D shows a combination of different lattice shapes and orientations. In this example, a gyroid- and primitive-shaped lattice include a mathematically optimized hybrid region therebetween. FIG. 15E shows an octet-truss lattice. FIGS. 15F and 15G show skeletal- and sheet-variants of a gyroid-shaped lattice. Likewise, FIGS. 15H and 15I show skeletal- and sheet-variants of a diamond-shaped lattice. FIG. 15J shows a vintiles-shaped lattice.

In another embodiment, the type of lattice shape is configurable as a heat exchanger. For example, FIG. 15K shows that, instead of a beam-shaped lattice structure 210, a dual gyroid-shape lattice 270 or other suitable triply periodic minimal surfaces (TPMS) based lattice may include a first set of channels 272 and a second set of channels 274 that are formed in a single lattice structure and separated (i.e., not in fluid communication) from each other due to internal surfaces of lattice 270. First set 272 carries a heat-transfer fluid 276 (e.g., ambient air pumped through lattice 270) and second set 274 carries a coolant 278 that is circulated to hot regions of a barrel or other extruder component. The same principle could be used for either liquid heating or cooling system by pumping hot water through one channel and cold water through the other.

Because barrel segment 164 is printed, it also accommodates internal voids or cell geometries (described previously), including those forming a lattice 210. Accordingly, barrel segment 164 is less susceptible to leaks when fluid is circulated through first region 236. This is so because there are no CV plugs, welds, seal rings, or holes since the coolant channels are constructed internally. The flow capacity and direction are also highly configurable and not limited by the size of cross drilling holes. The internal structure can include baffles and other features to direct the coolant flow though the internal structure.

The internal lattice structure (or other composite structures) also makes the barrels lighter compared to conventional (solid or single material) alternatives. The lighter barrels are easier to handle when performing maintenance or re-configuring the extruder. For instance, in one experiment, an overall weight reduction of 44% was achieved from a conventional barrel weighing 47.6 lbs to a printed barrel having lattice shapes. Likewise, experiments with lattice-filled screw segments shows reductions of 17% and 5.7% for, respectively, gyroid- and beam-shaped lattices.

### Controlled Porosity

As noted previously, the above-described lattice structures effect overall density of the part (vis-à-vis a solid part). With sufficiently small printed structures, AM techniques may be employed to reduce density to control porosity of printed material. Specifically, skilled persons will appreciate in light of this disclosure that AM extruder components may include a less dense (e.g., non-solid) interior having a density that is controllable by the intensity of the laser using DMLS technology. For example, FIGS. 16 and 17 shows a replaceable vent insert 290 having an integrally formed porous filter 294 in which the porosity is controlled based on the mesh size a lattice shape 300. An arcuate surface 310 of filter 294 conforms to that of an axial aperture such that surface fits flush in a barrel to expel gasses from extrudable material. A body of vent insert 290, however, is impervious to gas.

### Concluding Remarks

Skilled persons will appreciate that many changes may be made to the details of the above-described embodiments without departing from the underlying principles of the invention. For example, FGMs may be employed in transitional regions between a lattice structure and structural support frame. Also, the embodiments have applicability to twin-screw, single screw, one-piece barrel having a single barrel segment, and conical bore extruder machines. The scope of the present invention should, therefore, be determined by the following claims and equivalents.

1. An additively manufactured extruder component, comprising:
a surface layer configured to contact extrudable material, the surface layer having a first additively manufactured metal composition;
a base support for the surface layer, the base support having a second additively manufactured metal composition that is different from the first additively manufactured metal composition; and
a functionally graded material (FGM) formed from the first and second additively manufactured metal compositions connecting the surface layer to the base support.

2. The additively manufactured extruder component of claim 1, in which the first and second additively manufactured metal compositions include, respectively, first and second sintered metal materials that are different from each other.

3. The additively manufactured extruder component of claim 1, in which the first additively manufactured metal composition is harder, more wear resistant than the second additively manufactured metal composition that is more ductile than the first additively manufactured metal composition.

4. The additively manufactured extruder component of claim 1, in which the first additively manufactured metal composition is selected from a group comprising tool steels, powdered metal tool steels, stainless steels, nickel-based materials, cobalt-based materials, carbide metal matrix composites, ceramics metal matrix composites, and combinations thereof.

5. The additively manufactured extruder component of claim 1, in which the second additively manufactured metal composition is selected from a group comprising iron-based steel, stainless steel, nickel-based materials, and combinations thereof.

6. The additively manufactured extruder component of claim 1 comprising a screw segment.

7. The additively manufactured extruder component of claim 6, in which the screw segment comprises a kneading block extruder screw segment.

8. The additively manufactured extruder component of claim 6, in which the screw segment comprises a conveying extruder screw segment.

9. The additively manufactured extruder component of claim 8, in which the base support comprises an inner core defining screw flights, and in which the surface layer includes an outer shell hardfacing the screw flights, the outer shell at least partly covering channels between the screw flights.

10. The additively manufactured extruder component of claim 6, in which the base support comprises an inner core defining one or both lobes and screw flights, and in which the first additively manufactured metal composition forms a wear surface covering the one or both lobes and screw flights.

11. The additively manufactured extruder component of claim 1 comprising an extruder barrel segment.

12. The additively manufactured extruder component of claim 11, in which the base support defines an axial bore lining of the extruder barrel segment, and in which the surface layer includes an inner shell hardfacing the axial bore lining.

13. The additively manufactured extruder component of claim 12, in which the extruder barrel segment comprises a replaceable barrel sleeve.
